(19) United States
(12) Patent Application Publication
(10) Pub. No.: US 2026/0257898 A1
(43) Pub. Date: Sep. 3, 2026

(54) JACKING DEVICE

(71) Applicant: Youfu Liu, Jianshi (CN)

(72) Inventors: Yong Li, Jianshi (CN); Youfu Liu, Jianshi (CN)

(21) Appl. No.: 19/655,586

(22) Filed: Apr. 22, 2026

(30) Foreign Application Priority Data
May 10, 2025 (CN) 202510599282.X

(51) Int. Cl. B66F 3/02

(52) U.S. Cl. CPC B66F 3/02

(57) ABSTRACT

Disclosed is a jacking device. The jacking device includes a fixed part and a lifting part, where the fixed part includes a base and a rack, and the lifting part is slidably arranged on the rack. The lifting part is provided with a lifting plate, the lifting part is internally provided with a climbing mechanism, and the climbing mechanism includes a driving gear. The driving gear is directly or indirectly meshed with the rack, the lifting part is provided with a driving handle, an inner end of the driving handle is rotatably connected to the lifting part, and the inner end of the driving handle is provided with a driving element. The driving gear is sleeved on the driving element, a first clutch mechanism is arranged between the driving element and the driving gear, and the lifting part is provided with a locking mechanism.

### TECHNICAL FIELD

The present disclosure belongs to the technical field of jacking devices, and in particular to a jacking device.

### BACKGROUND

During indoor and outdoor building decorations, it is usually necessary to lift target objects such as suspended cabinets, window sills, wall tiles, furniture, and security doors to certain heights. Particularly during the tiling process, to ensure precise positioning and sustained stability, workers usually use jacking devices to support these objects. According to previous conventional methods, tile fragments, small wooden sticks, or other temporary supports, are used for support, which easily fall off during use, thereby causing instability, and moreover, and heights after adjustment may be inappropriate. Jacking devices have been developed to solve the above problems. After appropriate height adjustment, a jacking device is placed beneath to support the target object. For example, the Chinese Patent Publication No. CN220811743U discloses a finely adjustable jacking device. An adjustable handle is pressed until a control block is tilted and snap-fitted with a guide rod during movement downward, the control block and the guide rod are in a locked state, and in this case, the control block cannot move. When the user continues to press the adjustable handle, a lifting part moves upward, and a lifting plate on the lifting part moves upward with the lifting part, such that a target object is lifted for installation. It is will-known that energy loss is inevitable in the mechanical transmission process, but a structure for driving the lifting part to move upward generates more energy losses than that from gear transmission, such that the effort exerted by the user to press the adjustable handle is not effectively utilized, and the user needs to exert more physical efforts to control upward movement of the lifting part, which is not conducive to prolonged use of the jacking device. Therefore, it is necessary to provide a jacking device of a gear transmission structure to minimize energy loss during operation.

An objective of the present disclosure is to provide a jacking device of a simple structure, where upward movement of a lifting part along a rack is controlled by means of gear transmission, which improves efficiency of the gear transmission, substantially reduces energy loss during energy transfer, and more effectively utilizes the effort exerted by the user to press a driving handle, thereby minimizing physical fatigue and achieving a more labor-saving effect.

The objective of the present disclosure is realized as follows:

a jacking device, including a fixed part and a lifting part arranged on the fixed part, where the fixed part includes a base and a rack vertically arranged on the base, the lifting part is slidably arranged on the rack, the lifting part is provided with a lifting plate, the lifting part is internally provided with a climbing mechanism configured for driving the lifting part to move upward along the rack, the climbing mechanism includes a driving gear rotatably arranged inside the lifting part, the driving gear is directly or indirectly meshed with the rack, driven rotation of the driving gear drives the lifting part to move upward along the rack, the lifting part is provided with a driving handle, an inner end of the driving handle is rotatably connected to the lifting part, the inner end of the driving handle is provided with a driving element, the driving gear is sleeved on the driving element, a first clutch mechanism is arranged between the driving element and the driving gear, driven rotation of the driving handle drives the driving element to rotate synchronously, the driving element is locked against the driving gear through the first clutch mechanism, which drives the driving gear to rotate synchronously, in this case, the driving gear moves upward relative to the rack, which simultaneously drives the lifting part to move upward along the rack, when the driving handle is reset, the driving element and the driving gear are in a disengaged state, the lifting part is provided with a locking mechanism, and the locking mechanism limits downward movement of the lifting part.

Further, the climbing mechanism further includes a driven gear rotatably arranged inside the lifting part, the driving gear is meshed with the driven gear, the driven gear is meshed with the rack, the driven rotation of the driving gear drives the driven gear to rotate synchronously, and in this case, the driven gear moves upward along the rack, which simultaneously drives the lifting part to move upward along the rack.

Further, the lifting part is provided with a first mounting plate, the first clutch mechanism includes a plurality of first clutch pins, the first clutch pins are arranged on the first mounting plate, the driving element is annularly provided with a plurality of first clutch slots, and each of the first clutch slots has a shallow end with a depth less than a diameter of each of the first clutch pins and a deep end with a depth greater than or equal to the diameter of each of the first clutch pins; and when the first clutch pins are located at the deep ends of the first clutch slots, the driving element and the driving gear are in the disengaged state, the driven rotation of the driving handle drives the driving element to rotate synchronously, and in this case, the first clutch pins are located at the shallow ends of the first clutch slots and locked against the driving element and the driving gear, and the driving element and the driving gear are in a locked state.

Further, a rotating shaft is rotatably arranged inside the lifting part, the inner end of the driving handle is located inside the lifting part and fixedly connected to the rotating shaft, and the driving element is fixedly sleeved on the rotating shaft; and a first mounting rod is laterally arranged inside the lifting part, a second mounting rod is arranged on the driving handle, a first tension spring is arranged between the first mounting rod and the second mounting rod, and both ends of the first tension spring are connected to the first mounting rod and the second mounting rod.

Further, a locking mechanism includes a locking wheel fixedly arranged inside the lifting part and a locking gear sleeved on the locking wheel, the locking gear is meshed with the rack, a second clutch mechanism is arranged between the locking gear and the locking wheel, and the locking gear is locked against the locking wheel through the second clutch mechanism.

Further, the lifting part is internally provided with a mounting shaft, the locking wheel is fixedly sleeved on the mounting shaft, the locking gear is rotatably sleeved on the locking wheel, and a second mounting plate is further rotatably sleeved on the mounting shaft; the second clutch mechanism includes a plurality of second clutch pins arranged on the second mounting plate, and the locking wheel is provided with a plurality of second clutch slots, where each of the second clutch slots has a shallow end with a depth less than a diameter of each of the second clutch pins and a deep end with a depth greater than or equal to the diameter of each of the second clutch pins; when the second clutch pins are located at the shallow ends of the second clutch slots, the second clutch pins abut against the locking wheel and the locking gear, and the locking wheel and the locking gear are in the locked state; and a rapid drop switch is rotatably arranged on the lifting part, an inner end of the rapid drop switch is located inside the lifting part and abuts against the second mounting plate, when the rapid drop switch is pressed to push the second mounting plate to rotate, the second clutch pins on the second mounting plate move from the shallow ends of the second clutch slots to the deep ends of the second clutch slots, and the locking wheel and the locking gear are in the disengaged state.

Further, a third mounting rod is arranged at the inner end of the rapid drop switch, a fourth mounting rod is arranged on the second mounting plate, a second tension spring is arranged between the fourth mounting rod and the third mounting rod, both ends of the second tension spring are connected to the fourth mounting rod and the third mounting rod, the second mounting plate is provided with a fifth mounting rod, the first mounting rod is laterally arranged inside the lifting part, a third tension spring is arranged between the fifth mounting rod and the first mounting rod, and both ends of the third tension spring are connected to the first mounting rod and the fifth mounting rod.

Further, the lifting part is further provided with a fine-tuning mechanism, and the fine-tuning mechanism includes a pivot gear rotatably connected to the second mounting plate, a fine-tuning wheel rotatably arranged inside the lifting part, a fine-tuning gear sleeved on the fine-tuning wheel, and a fine-tuning switch that drives the fine-tuning wheel to rotate, where a third clutch mechanism is arranged between the fine-tuning gear and the fine-tuning wheel, the fine-tuning gear is locked against the fine-tuning wheel through the third clutch mechanism, the pivot gear is arranged above the locking gear and meshed with the locking gear, and the fine-tuning gear is meshed with the pivot gear.

Further, a connecting shaft is rotatably arranged inside the lifting part, an inner end of the fine-tuning switch is located inside the lifting part and fixedly connected to the connecting shaft, the fine-tuning wheel is fixedly sleeved on the connecting shaft, and a third mounting plate is further rotatably arranged on the connecting shaft; the third clutch mechanism includes a plurality of third clutch pins arranged on the third mounting plate, and a plurality of third clutch slots are formed on the fine-tuning wheel, where each of the third clutch slots has a shallow end with a depth less than a diameter of each of the third clutch pins and a deep end with a depth greater than or equal to the diameter of each of the third clutch pins; when the third clutch pins are located at the deep ends of the third clutch slots, the fine-tuning wheel and the fine-tuning gear are in the disengaged state, and when the fine-tuning switch is pressed, the connecting shaft and the fine-tuning wheel are driven to rotate; in this case, the third clutch pins are located at the shallow ends of the third clutch slots and abut against the fine-tuning wheel and the-tuning gear, and the fine-tuning wheel and the fine-tuning gear are in the locked state.

Further, a pressing port for an outer end of the fine-tuning switch to extend outside the lifting part is arranged at a top of the lifting part, an abutment platform is arranged inside the pressing port, the abutment platform is provided with an abutment groove, and a reset spring is arranged between the abutment platform and the fine-tuning switch; a bottom end of the reset spring is located inside the abutment groove and abuts against a bottom of the abutment groove, a lower surface of the fine-tuning switch is connected to a pressing plate spring, the pressing plate spring is L-shaped, and the pressing plate spring includes a horizontal portion and a vertical portion, where the horizontal portion is connected to the lower surface of the fine-tuning switch, a top end of the reset spring abuts against a bottom face of the horizontal portion, and the vertical portion is located on one side of the third mounting plate and abuts against the third mounting plate; a fixed shaft is further fixedly arranged inside the lifting part, the driven gear is sleeved on the fixed shaft, a fixed handle is further arranged on the lifting part, the fixed handle is located below the driving handle, an inner end of the fixed handle is located inside the lifting part and connected to the fixed shaft, the inner end of the fixed handle is provided with a limiting groove, and the driven gear is located inside the limiting groove.

Compared with the prior art, the present disclosure has the following outstanding and beneficial technical effects:

The present disclosure belongs to the technical field of jacking devices, and particularly refers to a jacking device; the jacking device includes a fixed part and a lifting part arranged on the fixed part, the fixed part includes a base and a rack vertically arranged on the base, the lifting part is provided with a lifting plate, and the lifting part is slidably arranged on the rack, where the lifting part moves upward along the rack primarily through a climbing mechanism located inside the lifting part; the climbing mechanism includes a driving gear rotatably arranged inside the lifting part, and the driving gear of the present disclosure is arranged to be directly meshed with the rack, or alternatively a driven gear is arranged between the driving gear and the rack, such that the driven gear is meshed with both the rack and the driving gear; in this case, the driving gear is indirectly meshed with the rack through the driven gear, an inner end of a driving handle on the lifting part is rotatably connected to the lifting part, the inner end of the driving handle is provided with a driving element, the driving gear is sleeved on the driving element, and a first clutch mechanism is arranged between the driving element and the driving gear; when the driving gear is directly meshed with the rack, the user first places the lifting plate beneath an object to be lifted and then lifts the driving handle, and in this case, the inner end of the driving handle rotates and drives the driving element to rotate counterclockwise; after rotation, the driving element is locked against the driving gear through the first clutch mechanism, and when the user continues to lift the driving handle, the driving gear is driven to rotate counterclockwise, and the driving gear, while moving upward along the rack, drives the entire lifting part to move upward along the rack simultaneously, such that the lifting plate on the lifting part moves upward with the lifting part simultaneously, thereby elevating the object; when the driving handle is lifted completely, an initial position is reset, the driving element rotates clockwise in this process, and the locked state of the driving element and the driving gear is released, that is, the driving element and the driving gear are in a disengaged state, such that clockwise rotation of the driving element cannot drive the driving gear to rotate clockwise, the driving gear is not driven to rotate clockwise when the driving handle returns to the initial position, the driving gear cannot move downward along the rack, and the lifting part returns to an initial position again; when the driving gear is indirectly meshed with the rack through the driven gear, and when the user presses down the driving handle, the inner end of the driving handle rotates and drives the driving element at the inner end of the driving handle to rotate clockwise; after rotation, the driving element is locked against the driving gear through the first clutch mechanism, and when the user continues to press down the driving handle, the driving gear is driven to rotate clockwise; the driving gear is meshed with the driven gear, and the driven gear is meshed with the rack, such that the clockwise rotation of the driving gear drives the driven gear to rotate counterclockwise, and in this case, the driven gear moves upward along the rack, the entire lifting part moves upward along the rack, and the lifting plate on the lifting part moves upward with the lifting part simultaneously, thereby elevating the object; when the driving handle is fully pressed down, the initial position is reset, the driving element rotates counterclockwise in this process, and the locked state of the driving element and the driving gear is released, that is, the driving element and the driving gear are in the disengaged state, such that the counterclockwise rotation of the driving element cannot drive the driving gear to rotate counterclockwise, the driving gear cannot drive the driven gear to rotate clockwise, and the driving handle cannot drive the driven gear to rotate clockwise when returning to the initial position, which prevents the driven gear from moving downward along the rack and causes the lifting part to return to the initial position again; for any jacking device currently available on the market, a structure for driving the lifting part to move upward generates more energy losses than that from gear transmission, such that the user needs to exert more physical efforts to control upward movement of the lifting part, which is not conducive to prolonged use of the jacking device; in the present disclosure, the driving gear is directly or indirectly meshed with the rack through gear transmission, which helps to control the upward movement of the lifting part along the rack, typically improves efficiency of the gear transmission up to over ninety percent, substantially reduces energy loss during energy transfer, and more effectively utilizes the effort exerted by the user to control the rotation of the driving handle, thereby minimizing physical fatigue and achieving a more labor-saving effect; and when the driving gear is indirectly meshed with the rack through the driven gear, the user may increase a radius of the driven gear or decrease a radius of the driving gear, such that the driving gear becomes a smaller gear and the driven gear becomes a larger gear, and the smaller gear drives the larger gear to rotate, which achieves a labor-saving effect, and facilitates prolonged use of the jacking device by the user.

### BRIEF DESCRIPTION OF THE DRAWINGS

FIG. 1 is a perspective view of the present disclosure.

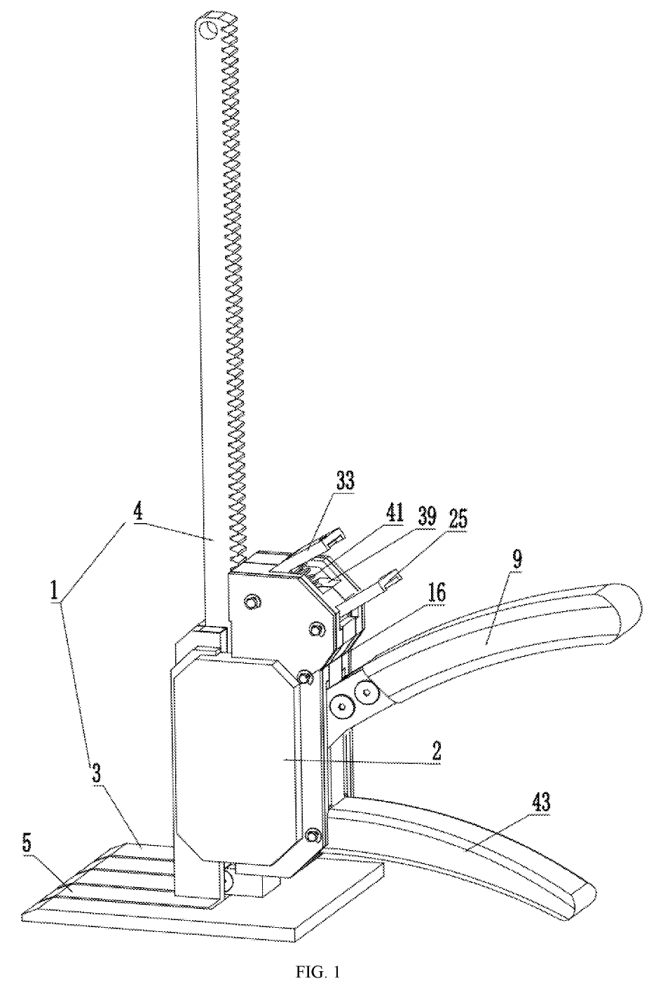

FIG. 2 is a sectional view of the present disclosure.

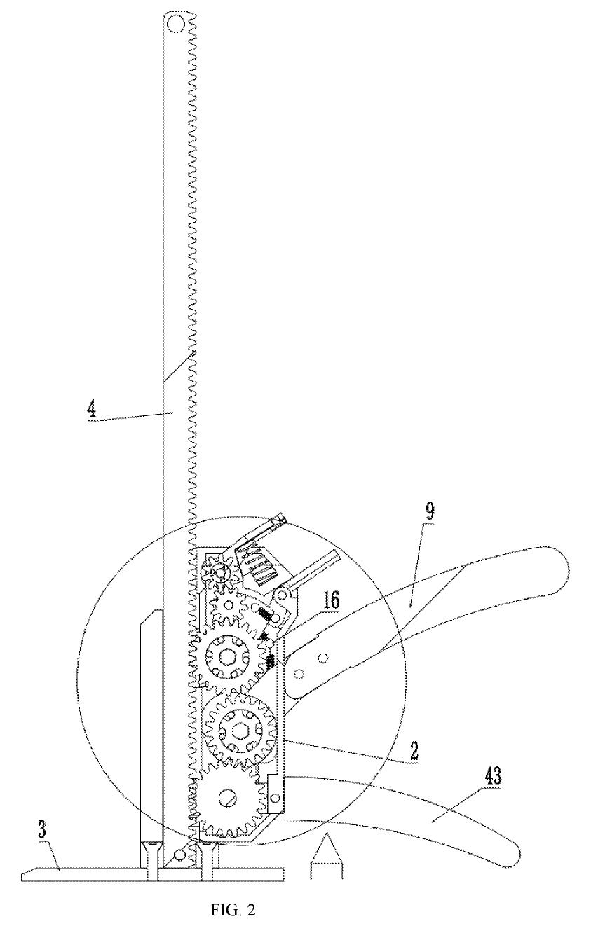

FIG. 3 is a partial enlarged view of a portion A in FIG. 2.

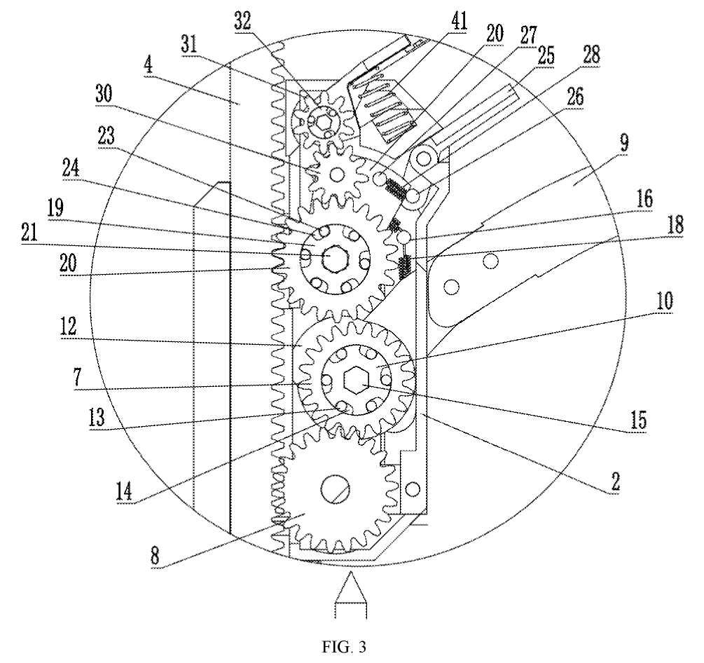

FIG. 4 is an exploded view of a fixed part and a lifting part of the present disclosure.

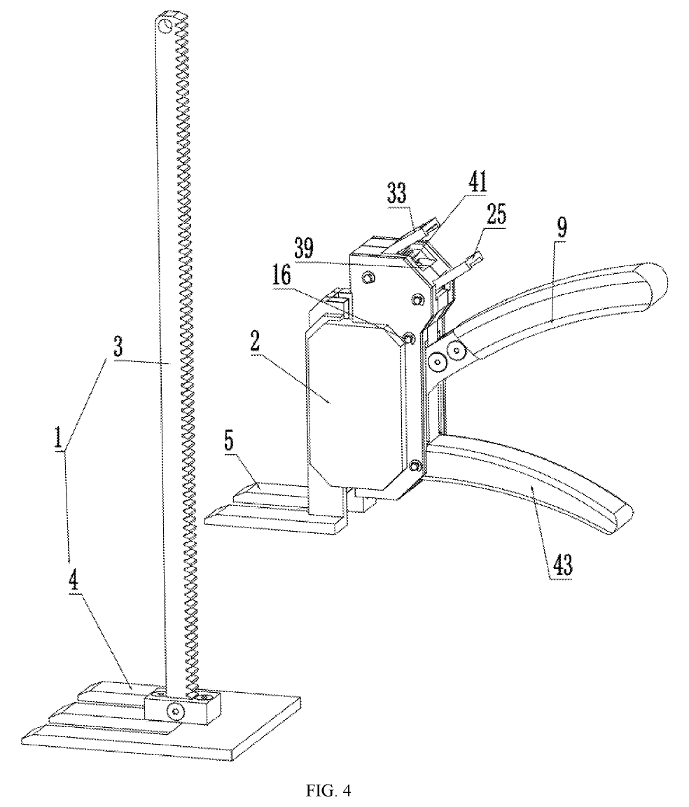

FIG. 5 is a schematic diagram 1 of an internal structure of a lifting part of the present disclosure.

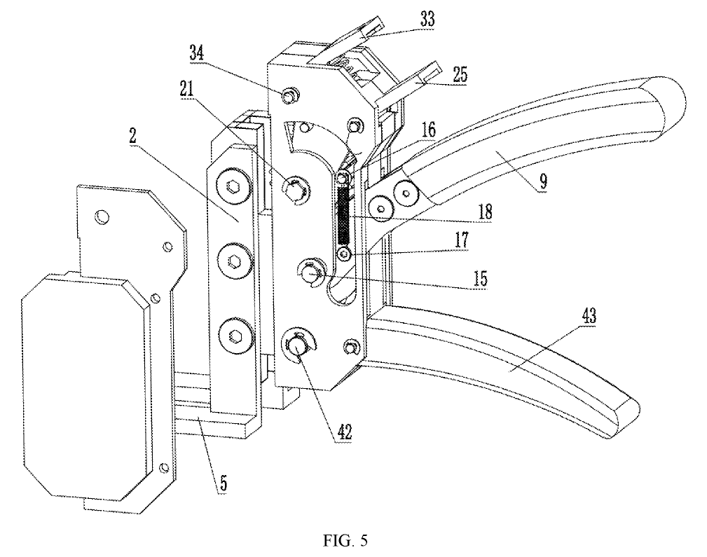

FIG. 6 is a schematic diagram 2 of an internal structure of a lifting part of the present disclosure.

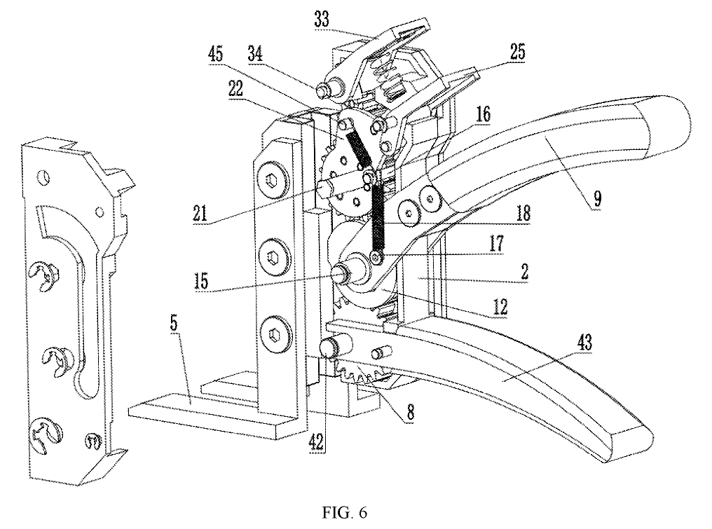

FIG. 7 is a schematic structural diagram of a climbing mechanism, a locking mechanism, and a fine-tuning mechanism of the present disclosure.

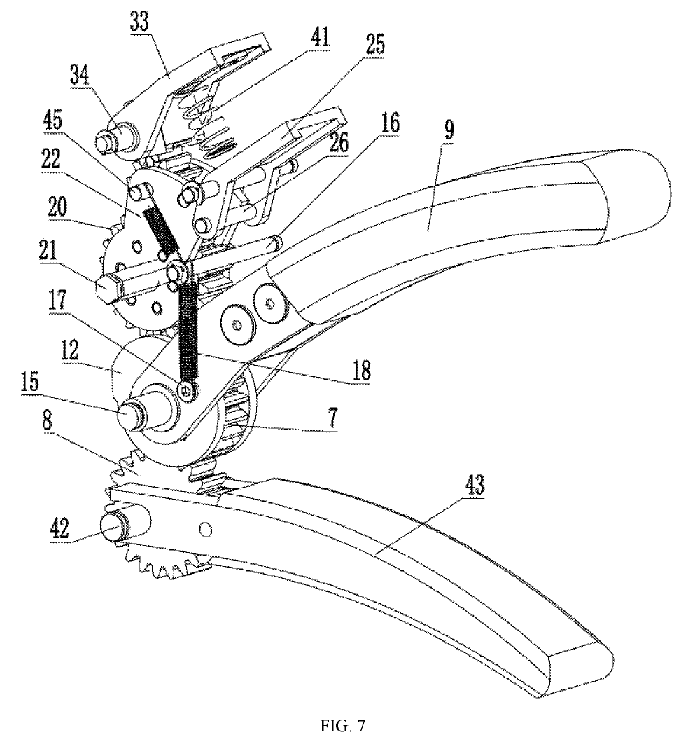

FIG. 8 is an exploded view of a first mounting plate and a driving gear of the present disclosure.

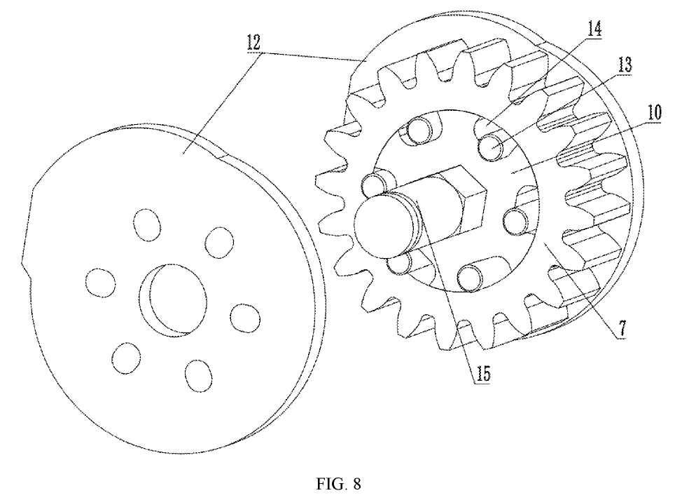

FIG. 9 is a schematic structural diagram of a driving gear and a driving element in a locked state according to the present disclosure.

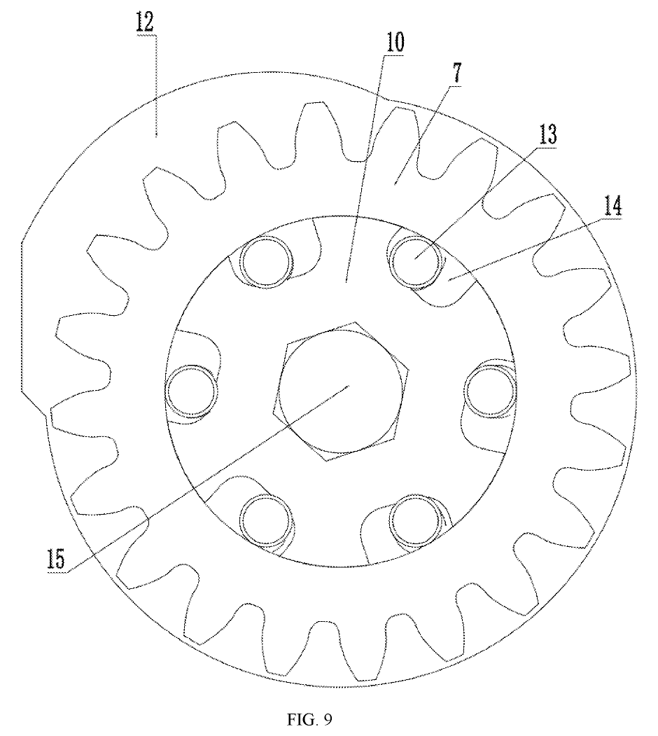

FIG. 10 is a schematic structural diagram of a driving gear and a driving element in a disengaged state according to the present disclosure.

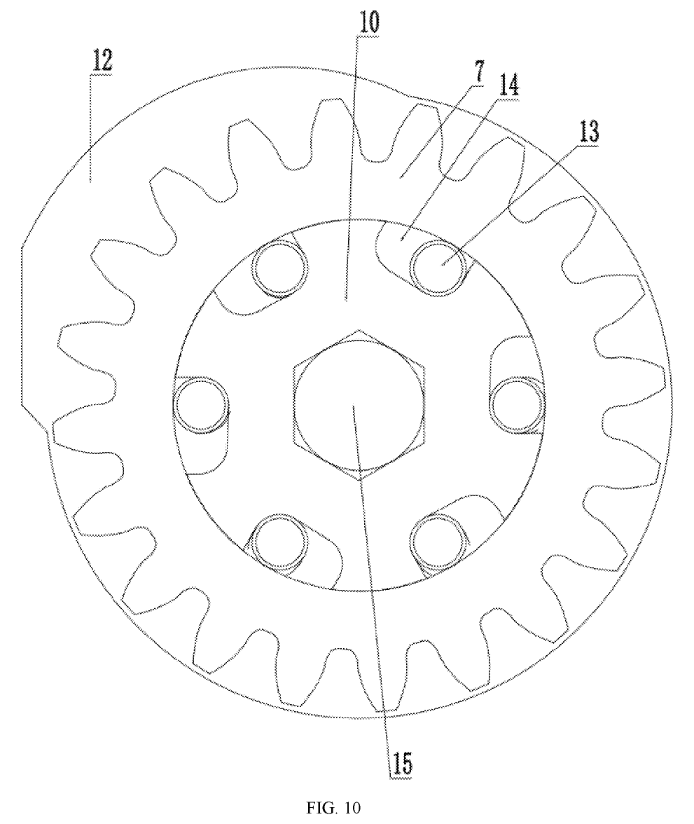

FIG. 11 is a schematic structural diagram of a fine-tuning mechanism, a locking gear, and a second mounting plate according to the present disclosure.

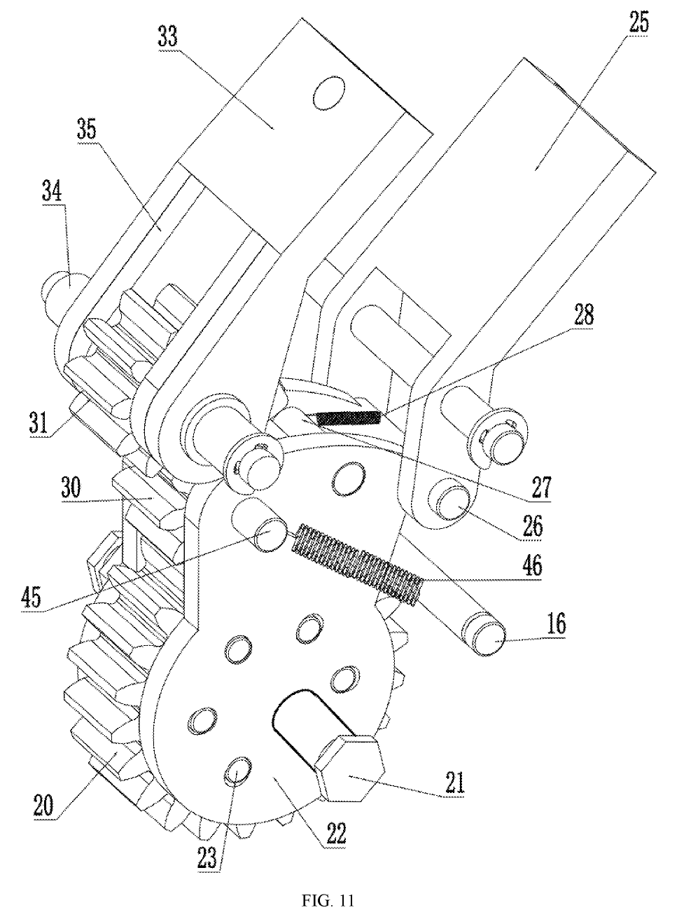

FIG. 12 is another schematic structural diagram of a fine-tuning mechanism, a locking gear, and a second mounting plate according to the present disclosure.

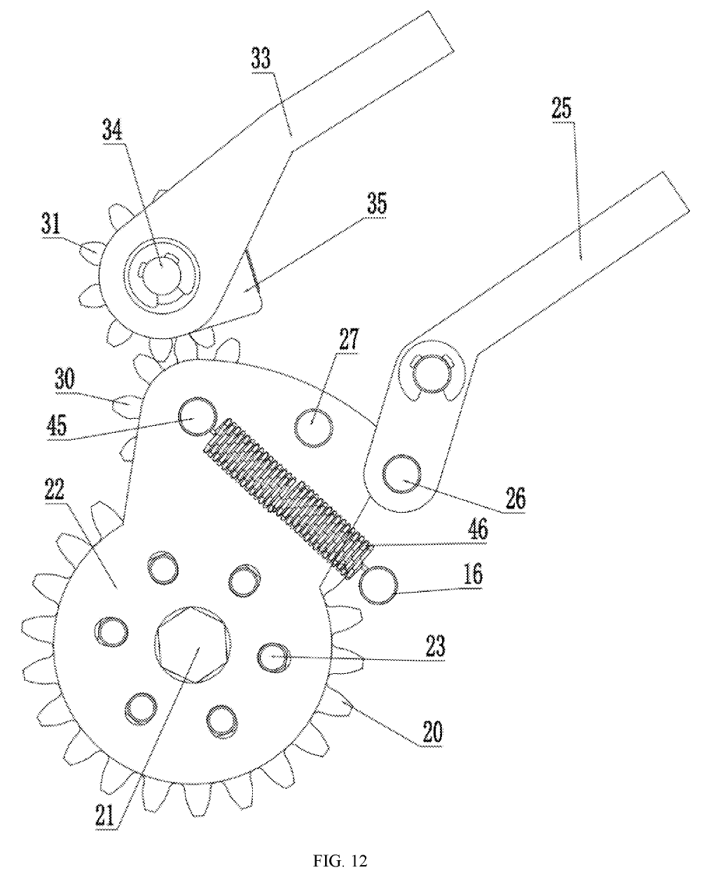

FIG. 13 is a schematic structural diagram of a pivot gear, a fine-tuning gear, and a locking gear according to the present disclosure.

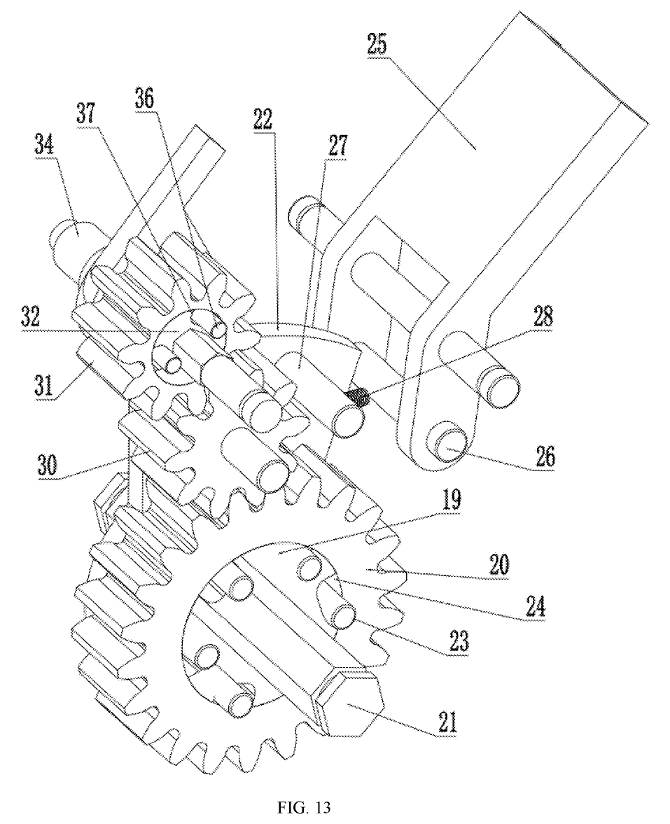

FIG. 14 is another schematic structural diagram of a pivot gear, a fine-tuning gear, and a locking gear according to the present disclosure.

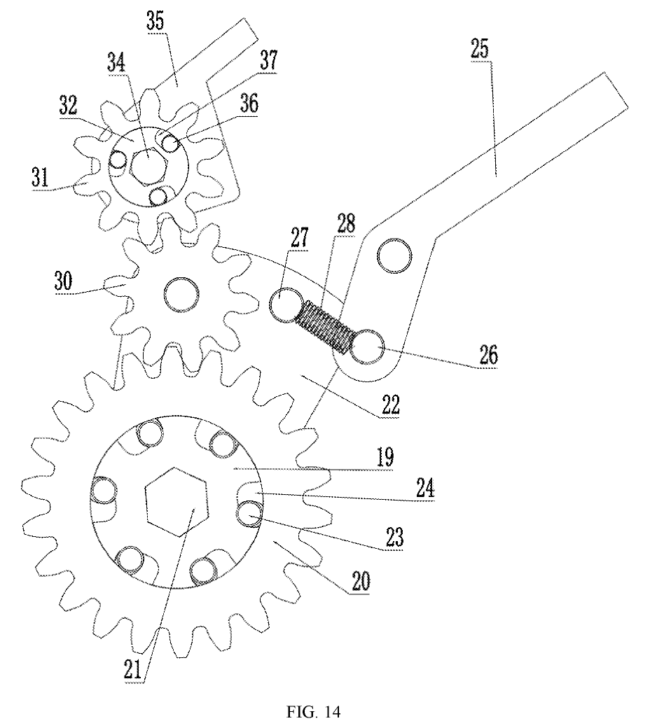

FIG. 15 is an exploded view of a fine-tuning switch and a pressing plate spring according to the present disclosure.

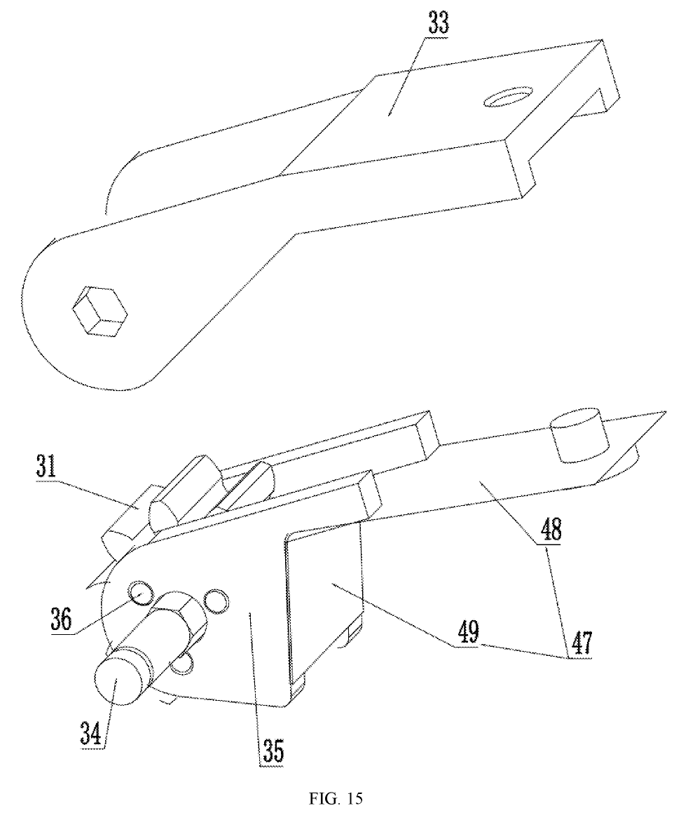

FIG. 16 is an exploded view of a third mounting plate and a pressing plate spring according to the present disclosure.

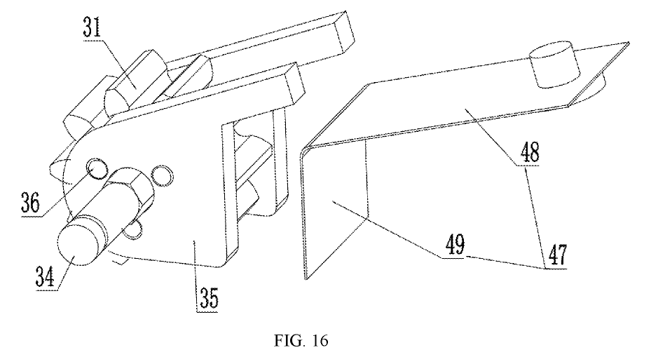

FIG. 17 is a perspective view of a lifting part of the present disclosure.

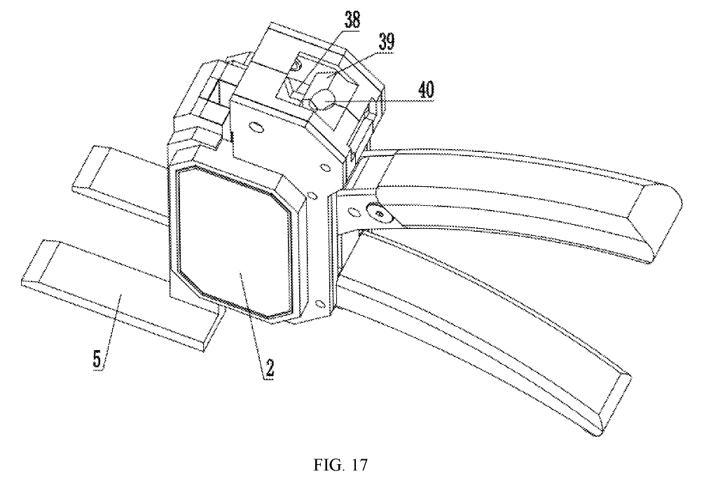

### Reference numerals in the figures

1-fixed part; 2-lifting part; 3-base; 4-rack; 5-lifting plate; 7-driving gear; 8-driven gear; 9-driving handle; 10-driving element; 12-first mounting plate; 13-first clutch pin; 14-first clutch slot; 15-rotating shaft; 16-first mounting rod; 17-second mounting rod; 18-first tension spring; 19-locking wheel; 20-locking gear; 21-mounting shaft; 22-second mounting plate; 23-second clutch pin; 24-second clutch slot; 25-rapid drop switch; 26-third mounting rod; 27-fourth mounting rod; 28-second tension spring; 30-pivot gear; 31-fine-tuning gear; 32-fine-tuning wheel; 33-fine-tuning switch; 34-connecting shaft; 35-third mounting plate; 36-third clutch pin; 37-third clutch slot; 38-pressing port; 39-abutment platform; 40-abutment groove; 41-reset spring; 42-fixed shaft; 43-fixed handle; 44-limiting groove; 45-fifth mounting rod; 46-third tension spring; 47-pressing plate spring; 48-horizontal portion; and 49-vertical portion.

### DETAILED DESCRIPTIONS OF THE EMBODIMENTS

The present disclosure will be further described below with reference to specific examples:

The present disclosure belongs to the technical field of jacking devices, and particularly refers to a jacking device; the jacking device includes a fixed part 1 and a lifting part 2 arranged on the fixed part 1, the fixed part 1 includes a base 3 and a rack 4 vertically arranged on the base 3, the lifting part 2 is provided with a lifting plate 5, and the lifting part 2 is slidably arranged on the rack 4, where the lifting part 2 moves upward along the rack 4 primarily through a climbing mechanism located inside the lifting part 2; the climbing mechanism includes a driving gear 7 rotatably arranged inside the lifting part 2, and the driving gear 7 of the present disclosure is arranged to be directly meshed with the rack 4, or alternatively a driven gear 8 is arranged between the driving gear 7 and the rack 4, such that the driven gear 8 is meshed with both the rack 4 and the driving gear 7; in this case, the driving gear 7 is indirectly meshed with the rack 4 through the driven gear 8, an inner end of a driving handle 9 on the lifting part 2 is rotatably connected to the lifting part 2, the inner end of the driving handle 9 is provided with a driving element 10, the driving gear 7 is sleeved on the driving element 10, and a first clutch mechanism is arranged between the driving element 10 and the driving gear 7; when the driving gear 7 is directly meshed with the rack 4, the user first places the lifting plate 5 beneath an object to be lifted and then lifts the driving handle 9, and in this case, the inner end of the driving handle 9 rotates and drives the driving element 10 to rotate counterclockwise; after rotation, the driving element 10 is locked against the driving gear 7 through the first clutch mechanism, and when the user continues to lift the driving handle 9, the driving gear 7 is driven to rotate counterclockwise, and the driving gear 7, while moving upward along the rack 4, drives the entire lifting part 2 to move upward along the rack 4 simultaneously, such that the lifting plate 5 on the lifting part 2 moves upward with the lifting part 2 simultaneously, thereby elevating the object; when the driving handle 9 is lifted completely, an initial position is reset, the driving element 10 rotates clockwise in this process, and the locked state of the driving element 10 and the driving gear 7 is released, that is, the driving element and the driving gear are in a disengaged state, such that clockwise rotation of the driving element 10 cannot drive the driving gear 7 to rotate clockwise, the driving gear 7 is not driven to rotate clockwise when the driving handle 9 returns to the initial position, the driving gear 7 cannot move downward along the rack 4, and the lifting part 2 returns to an initial position again; when the driving gear 7 is indirectly meshed with the rack 4 through the driven gear 8, and when the user presses down the driving handle 9, the inner end of the driving handle 9 rotates and drives the driving element 10 at the inner end of the driving handle 9 to rotate clockwise; after rotation, the driving element 10 is locked against the driving gear 7 through the first clutch mechanism, and when the user continues to press down the driving handle 9, the driving gear 7 is driven to rotate clockwise; the driving gear 7 is meshed with the driven gear 8, and the driven gear 8 is meshed with the rack 4, such that the clockwise rotation of the driving gear 7 drives the driven gear 8 to rotate counterclockwise, and in this case, the driven gear 8 moves upward along the rack 4, the entire lifting part 2 moves upward along the rack 4, and the lifting plate 5 on the lifting part 2 moves upward with the lifting part 2 simultaneously, thereby elevating the object; when the driving handle 9 is fully pressed down, the initial position is reset, the driving element 10 rotates counterclockwise in this process, and the locked state of the driving element 10 and the driving gear 7 is released, that is, the driving element 10 and the driving gear 7 are in the disengaged state, such that the counterclockwise rotation of the driving element 10 cannot drive the driving gear 7 to rotate counterclockwise, the driving gear 7 cannot drive the driven gear 8 to rotate clockwise, and the driving handle 9 cannot drive the driven gear 8 to rotate clockwise when returning to the initial position, which prevents the driven gear 8 from moving downward along the rack 4 and causes the lifting part 2 to return to the initial position again; for any jacking device currently available on the market, a structure for driving the lifting part 2 to move upward generates more energy losses than that from gear transmission, such that the user needs to exert more physical efforts to control upward movement of the lifting part 2, which is not conducive to prolonged use of the jacking device; in the present disclosure, the driving gear 7 is directly or indirectly meshed with the rack 4 through gear transmission, which helps to control the upward movement of the lifting part 2 along the rack 4, typically improves efficiency of the gear transmission up to over ninety percent, substantially reduces energy loss during energy transfer, and more effectively utilizes the effort exerted by the user to control the rotation of the driving handle 9, thereby minimizing physical fatigue and achieving a more labor-saving effect; and when the driving gear 7 is indirectly meshed with the rack 4 through the driven gear 8, the user may increase a radius of the driven gear 8 or decrease a radius of the driving gear 7, such that the driving gear 7 becomes a smaller gear and the driven gear 8 becomes a larger gear, and the smaller gear drives the larger gear to rotate, which achieves a labor-saving effect, and facilitates prolonged use of the jacking device by the user.

Preferably, the climbing mechanism further includes the driven gear 8 rotatably arranged inside the lifting part 2, the driving gear 7 is meshed with the driven gear 8, the driven gear 8 is meshed with the rack 4, the driven rotation of the driving gear 7 drives the driven gear 8 to rotate synchronously, and in this case, the driven gear 8 moves upward along the rack 4, which simultaneously drives the lifting part 2 to move upward along the rack 4; and arrangement of the driven gear 8 causes the driving gear 7 to be meshed with the rack 4 indirectly through the driven gear 8, and the driven gear 8 is rotatably arranged inside the lifting part 2, such that the driven gear 8 is smoothly driven by the driving gear 7.

Preferably, the lifting part 2 is provided with a first mounting plate 12, the first clutch mechanism includes a plurality of first clutch pins 13, the first clutch pins 13 are arranged on the first mounting plate 12, the driving element 10 is annularly provided with a plurality of first clutch slots 14, and each of the first clutch slots 14 has a shallow end with a depth less than a diameter of each of the first clutch pins 13 and a deep end with a depth greater than or equal to the diameter of each of the first clutch pins 13; when the first clutch pins 13 are located at the deep ends of the first clutch slots 14, the driving element 10 and the driving gear 7 are in a disengaged state, the driven rotation of the driving handle 9 drives the driving element 10 to rotate synchronously, and in this case, the first clutch pins 13 are located at the shallow ends of the first clutch slots 14 and locked against the driving element 10 and the driving gear 7, and the driving element 10 and the driving gear 7 are in a locked state; the first mounting plate 12 is configured to mount the plurality of first clutch pins 13, and since each of the first clutch slots 14 has the shallow end with the depth less than the diameter of each of the first clutch pins 13 and the deep end with the depth greater than or equal to the diameter of each of the first clutch pins 13, the depth of the deep end of the first clutch slot 14 may be arranged to be greater than or equal to the diameter of the first clutch pin 13; when the depth of the first clutch slot 14 is greater than the diameter of the first clutch pin 13, that is, when the first clutch pins 13 are located at the deep ends of the first clutch slot 14, the first clutch pins 13 are completely disengaged from the driving element 10 and the driving gear 7; when the depth of the first clutch slot 14 is equal to the diameter of the first clutch pin 13, that is, when the first clutch pins 13 are located at the deep ends of the first clutch slots 14, upper and lower ends of the first clutch pins 13 just come into contact with the driving element 10 and the driving gear 7, and the first clutch pins 13 are not locked against the driving element 10 and the driving gear 7, while the driving element 10 and the driving gear 7 are in a disengaged state; when the driving handle 9 is in an initial state, the first clutch pins 13 are located at the deep ends of the first clutch slots 14, the depth of the deep end of the first clutch slot 14 is greater than or equal to the diameter of the first clutch pin 13, the first clutch pins 13 do not lock the driving element 10 and the driving gear 7 together, the driving element 10 and the driving gear 7 are in the disengaged state, and the driving gear 7 freely rotates relative to the driving element 10; when the user presses the driving handle 9 to move downward, the driving handle 9 drives the driving element 10 to rotate clockwise, the first clutch slots 14 on the driving element 10 rotate clockwise synchronously, and the first clutch pins 13 finally move from the deep ends of the first clutch slots 14 to the shallow ends of the first clutch slots 14; since the depth of the shallow end of the first clutch slot 14 is less than the diameter of the first clutch pin 13, the first clutch pins 13 are locked against both the driving element 10 and the driving gear 7, and the driving element 10 is locked against the driving gear 7 through the first clutch pins 13; in this case, when the user continues to rotate the driving handle 9, the first clutch pins 13, the driving gear 7, and the driving element 10 are driven to rotate synchronously, and when the driving handle 9 rotates downward to a maximum travel range, an upward movement of the lifting part 2 has been completed; in this case, to perform a second upward movement of the lifting part 2, the driving handle 9 returns to the initial state, the upward movement of the driving handle 9 drives the driving element 10 to rotate counterclockwise, and the first clutch slots 14 on the driving element 10 also rotate counterclockwise with the driving element 10; as the first clutch slots 14 rotate, the first clutch pins 13 re-enter the deep ends of the first clutch slots 14, the locking state of the first clutch pins 13 against the driving element 10 and the driving gear 7 is released, and the driving element 10 and the driving gear 7 re-enter the disengaged state, such that the counterclockwise rotation of the driving element 10 cannot drive the driving gear 7 to rotate counterclockwise, and ultimately the driving gear 7 and the driven gear 8 remain unchanged, which avoids the situation that the clockwise rotation of the driven gear 8 drives the lifting part 2 to return to the initial position, thereby ensuring normal use of the jacking device.

Preferably, a rotating shaft 15 is rotatably arranged inside the lifting part 2, the inner end of the driving handle 9 is located inside the lifting part 2 and fixedly connected to the rotating shaft 15, and the driving element 10 is fixedly sleeved on the rotating shaft 15; a first mounting rod 16 is laterally arranged inside the lifting part 2, a second mounting rod 17 is arranged on the driving handle 9, a first tension spring 18 is arranged between the first mounting rod 16 and the second mounting rod 17, and both ends of the first tension spring 18 are connected to the first mounting rod 16 and the second mounting rod 17; the inner end of the driving handle 9 is located inside the lifting part 2 and fixedly connected to the rotating shaft 15, such that the inner end of the driving handle 9 is smoothly rotatably connected to the lifting part 2; since the rotating shaft 15 is rotatably arranged inside the lifting part 2 and the driving element 10 is fixedly sleeved on the rotating shaft 15, when the user presses down the driving handle 9 to rotate, the rotating shaft 15 is driven to rotate, and the rotation of the rotating shaft 15 smoothly drives the driving element 10 to rotate; when the driving handle 9 rotates downward, the second mounting rod 17 on the driving handle 9 rotates downward synchronously with the driving handle 9, such that the first tension spring 18 located between the first mounting rod 16 and the second mounting rod 17 is elongated by the second mounting rod 17; when the user releases the driving handle 9, the elongated first tension spring 18 pulls the second mounting rod 17 to move upward to reset, and ultimately the driving handle 9 returns to the initial position; and when upward movement of the lifting part 2 along the rack 4 is completed, the driving handle 9 automatically resets to the initial position, and manual resetting of the driving handle 9 by the user is not required, thereby facilitating use of the jacking device.

Preferably, a locking mechanism includes a locking wheel 19 fixedly arranged inside the lifting part 2 and a locking gear 20 sleeved on the locking wheel 19, the locking gear 20 is meshed with the rack 4, a second clutch mechanism is arranged between the locking gear 20 and the locking wheel 19, and the locking gear 20 is locked against the locking wheel 19 through the second clutch mechanism; the locking wheel 19 is fixedly arranged inside the lifting part 2, and the locking gear 20 is locked against the locking wheel 19 through the second clutch mechanism between the locking gear 20 and the locking wheel 19, which effectively limits the rotation of the locking wheel 19 relative to the locking gear 20; and equivalently the locking gear 20 is fixedly arranged inside the lifting part 2, such that when the lifting part 2 moves upward, the locking gear 20 and the rack 4 are in the locked state as the locking gear 20 cannot rotate, which prevents the lifting part 2 from returning to an original position when the lifting part 2 moves upward.

Preferably, the lifting part 2 is internally provided with a mounting shaft 21, the locking wheel 19 is fixedly sleeved on the mounting shaft 21, the locking gear 20 is rotatably sleeved on the locking wheel 19, and a second mounting plate 22 is further rotatably sleeved on the mounting shaft 21; the second clutch mechanism includes a plurality of second clutch pins 23 arranged on the second mounting plate 22, and the locking wheel 19 is provided with a plurality of second clutch slots 24, where each of the second clutch slots 24 has a shallow end with a depth less than a diameter of each of the second clutch pins 23 and a deep end with a depth greater than or equal to the diameter of each of the second clutch pins 23; when the second clutch pins 23 are located at the shallow ends of the second clutch slots 24, the second clutch pins 23 abut against the locking wheel 19 and the locking gear 20, and the locking wheel 19 and the locking gear 20 are in the locked state; a rapid drop switch 25 is rotatably arranged on the lifting part 2, an inner end of the rapid drop switch 25 is located inside the lifting part 2 and abuts against the second mounting plate 22, when the rapid drop switch 25 is pressed to push the second mounting plate 22 to rotate, the second clutch pins 23 on the second mounting plate 22 move from the shallow ends of the second clutch slots 24 to the deep ends of the second clutch slots 24, and the locking wheel 19 and the locking gear 20 are in the disengaged state; arrangement of the mounting shaft 21 ensures that both the locking wheel 19 and the second mounting plate 22 are mounted inside the lifting part 2, and prevents the locking wheel 19 and the second mounting plate 22 from moving freely inside the lifting part 2; and since each of the second clutch slots 24 has the shallow end with the depth less than the diameter of each of the second clutch pins 23 and the deep end with the depth greater than or equal to the diameter of each of the second clutch pins 23, the depth of the deep end of the second clutch slot 24 of the present disclosure may be arranged to be greater than or equal to the diameter of the second clutch pin 23; when the depth of the second clutch slot 24 is greater than the diameter of the second clutch pin 23, that is, when the second clutch pins 23 enter the deep ends of the second clutch slots 24, the second clutch pins 23 are completely disengaged from the locking gear 20 and the locking wheel 19; when the depth of the second clutch slot 24 is equal to the diameter of the second clutch pin 23, that is, when the second clutch pins 23 enter the deep ends of the second clutch slots 24, upper and lower ends of the second clutch pins 23 just come into contact with the locking gear 20 and the locking wheel 19, and the second clutch pins 23 are not locked against the locking gear 20 and the locking wheel 19, while the locking gear 20 and the locking wheel 19 are in the disengaged state; when the rapid drop switch 25 is in an initial state, the second clutch pins 23 on the second mounting plate 22 are located at the shallow ends of the second clutch slots 24; since the depth of the shallow end of the second clutch slot 24 is less than the diameter of the second clutch pin 23, and the second clutch pins 23 are locked against both the locking gear 20 and the locking wheel 19, such that the locking gear 20 and the locking wheel 19 are in the locked state; when the user presses the driving handle 9, the driven gear 8 ultimately rotates counterclockwise, and the driven gear 8 moves upward along the rack 4 to drive the upward movement of the entire lifting part 2; in this process, the locking gear 20 is under the action of a thrust from the upward movement of the lifting part 2, the locking gear 20 is forced to rotate counterclockwise, and in this case, the locking gear 20 drives the second clutch pins 23 to slightly move toward the deep ends of the second clutch slots 24 for a certain distance, such that the second clutch pins 23 are unlocked from both the locking gear 20 and the locking wheel 19, the locking gear 20 and the locking wheel 19 are in the disengaged state, and the locking gear 20 freely rotates counterclockwise; when a state of snap-fit engagement between the locking gear 20 and the rack 4 is released, the locking gear 20 moves upward along the rack 4, and the entire lifting part 2 smoothly moves upward along the rack 4, thereby ensuring normal use of the jacking device; since the rapid drop switch 25 is rotatably arranged on the lifting part 2 and the inner end of the rapid drop switch 25 abuts against the second mounting plate 22, the user presses the rapid drop switch 25 on the lifting part 2 to enable the lifting part 2 to quickly descend to an initial position, the rapid drop switch 25 rotates downward to drive the second mounting plate 22 to rotate counterclockwise relative to the mounting shaft 21, and the second mounting plate 22 rotates counterclockwise to drive the second clutch pins 23 on the second mounting plate 22 to rotate synchronously; in this case, the second clutch pins 23 move from the shallow ends of the second clutch slots 24 to the deep ends thereof; since the depth of the deep end of the second clutch slot 24 is greater than or equal to the diameter of the second clutch pin 23, the second clutch pins 23 are unlocked against both the locking gear 20 and the locking wheel 19, the locking gear 20 and the locking wheel 19 are in the disengaged state, and the locking gear 20 rotates freely relative to the locking wheel 19, such that the locked state of the locking gear 20 and the rack 4 is released; and in this case, due to a weight of the entire lifting part 2, the lifting part 2 automatically drops back to the initial position, and in this process, both the locking gear 20 and the driven gear 8 rotate clockwise, and the lifting part 2 returns to the initial position at a constant speed along the rack 4.

Preferably, a third mounting rod 26 is arranged at the inner end of the rapid drop switch 25, a fourth mounting rod 27 is arranged on the second mounting plate 22, a second tension spring 28 is arranged between the fourth mounting rod 27 and the third mounting rod 26, both ends of the second tension spring 28 are connected to the fourth mounting rod 27 and the third mounting rod 26, the second mounting plate 22 is provided with a fifth mounting rod 45, the first mounting rod 16 is laterally arranged inside the lifting part 2, a third tension spring 46 is arranged between the fifth mounting rod 45 and the first mounting rod 16, and both ends of the third tension spring 46 are connected to the first mounting rod 16 and the fifth mounting rod 45; arrangement of the second tension spring 28 ensures that a side face of the second mounting plate 22 is always in contact with the inner end of the rapid drop switch 25, such that when the user presses the rapid drop switch 25, the second mounting plate 22 is directly driven to rotate, and under support of the second mounting plate 22, the rapid drop switch 25 is maintained in a stable state without wobbling; when the lifting part 2 moves upward, the locking gear 20 drives the second clutch pins 23 to move slightly toward the deep ends of the second clutch slots 24 for a certain distance, and the second mounting plate 22 for mounting the second clutch pins 23 rotates at a certain angle; since both ends of the third tension spring 46 are connected to the fifth mounting rod 45 on the second mounting plate 22 and the first mounting rod 16 fixedly arranged inside the lifting part 2, the third tension spring 46 is pulled when the second mounting plate 22 rotates, and the third tension spring 46 is elongated; when the upward movement of the lifting part 2 is completed, the elongated third tension spring 46 pulls the second mounting plate 22 back to an initial position thereof, such that the second clutch pins 23 on the second mounting plate 22 re-move to the shallow ends of the second clutch slots 24, and the second clutch pins 23 are re-locked against the locking gear 20 and the locking wheel 19; and in this case, the locking gear 20 re-rotates, and the locking gear 20 and the rack 4 re-enter the locked state, which prevents the lifting part 2 from returning to the original position after the upward movement.

Preferably, the lifting part 2 is further provided with a fine-tuning mechanism, and the fine-tuning mechanism includes a pivot gear 30 rotatably connected to the second mounting plate 22, a fine-tuning wheel 32 rotatably arranged inside the lifting part 2, a fine-tuning gear 31 sleeved on the fine-tuning wheel 32, and a fine-tuning switch 33 that drives the fine-tuning wheel 32 to rotate, where a third clutch mechanism is arranged between the fine-tuning gear 31 and the fine-tuning wheel 32, the fine-tuning gear 31 is locked against the fine-tuning wheel 32 through the third clutch mechanism, the pivot gear 30 is arranged above the locking gear 20 and meshed with the locking gear 20, and the fine-tuning gear 31 is meshed with the pivot gear 30; a connecting shaft 34 is rotatably arranged inside the lifting part 2, an inner end of the fine-tuning switch 33 is located inside the lifting part 2 and fixedly connected to the connecting shaft 34, the fine-tuning wheel 32 is fixedly sleeved on the connecting shaft 34, and a third mounting plate 35 is further rotatably arranged on the connecting shaft 34; the third clutch mechanism includes a plurality of third clutch pins 36 arranged on the third mounting plate 35, and a plurality of third clutch slots 37 are formed on the fine-tuning wheel 32, where each of the third clutch slots 37 has a shallow end with a depth less than a diameter of each of the third clutch pins 36 and a deep end with a depth greater than or equal to the diameter of each of the third clutch pins 36; when the third clutch pins 36 are located at the deep ends of the third clutch slots 37, the fine-tuning wheel 32 and the fine-tuning gear 31 are in the disengaged state, and when the fine-tuning switch 33 is pressed, the connecting shaft 34 and the fine-tuning wheel 32 are driven to rotate; in this case, the third clutch pins 36 are located at the shallow ends of the third clutch slots 37 and abut against the fine-tuning wheel 32 and the-tuning gear 31, and the fine-tuning wheel 32 and the fine-tuning gear 31 are in the locked state; the user presses the fine-tuning switch 33 to fine-tune a lifting height of an target object downward; the inner end of the fine-tuning switch 33 is located inside the lifting part 2 and fixedly connected to the connecting shaft 34, the fine-tuning wheel 32 is fixedly sleeved on the connecting shaft 34, and the third mounting plate 35 is rotatably connected to the connecting shaft 34, such that when the user presses the fine-tuning switch 33, the fine-tuning switch 33 drives the connecting shaft 34 to rotate, and the connecting shaft 34 drives the fine-tuning wheel 32 to rotate; since each of the third clutch slots 37 has the shallow end with the depth less than the diameter of each of the third clutch pins 36 and the deep end with the depth greater than or equal to the diameter of each of the third clutch pins 36, the depth of the deep end of the third clutch slot 37 of the present disclosure may be arranged to be greater than or equal to the diameter of the third clutch pin 36; when the depth of the third clutch slot 37 is greater than the diameter of the third clutch pin 36, that is, when the third clutch pins 36 enter the deep ends of the third clutch slots 37, the third clutch pins 36 are completely disengaged from the fine-tuning wheel 32 and the fine-tuning gear 31; when the depth of the third clutch slot 37 is equal to the diameter of the third clutch pin 36, that is, when the third clutch pins 36 enter the deep ends of the third clutch slots 37, upper and lower ends of the third clutch pins 36 just come into contact with the fine-tuning wheel 32 and the fine-tuning gear 31, and the third clutch pins 36 are not locked against the fine-tuning wheel 32 and the fine-tuning gear 31, while the fine-tuning wheel 32 and the fine-tuning gear 31 are in the disengaged state; when the fine-tuning switch 33 is in an initial position, the third clutch pins 36 on the third mounting plate 35 are located at the deep ends of third clutch slots 37; since the depth of the deep end of the third clutch slot 37 is greater than or equal to the diameter of the third clutch pin 36, the fine-tuning wheel 32 and the fine-tuning gear 31 are in the disengaged state; when the fine-tuning wheel 32 rotates, the third clutch slots 37 on the fine-tuning wheel 32 rotate synchronously, and the third clutch pins 36 move from the deep ends of the third clutch slots 37 to the shallow ends of third clutch slots 37; since the depth of the shallow end of the third clutch slot 37 is less than the diameter of the third clutch pin 36, the third clutch pins 36 are locked against both the fine-tuning wheel 32 and the fine-tuning gear 31, and the fine-tuning wheel 32 is locked against the fine-tuning gear 31 through the first clutch pins 13; when the user continues to press the fine-tuning switch 33, the fine-tuning gear 31 is driven to rotate clockwise; since the pivot gear 30 is arranged above the locking gear 20 and meshed with the locking gear 20, and also since the fine-tuning gear 31 is meshed with the pivot gear 30, the clockwise rotation of the fine-tuning gear 31, under normal circumstances, drives the pivot gear 30 to rotate counterclockwise, and the pivot gear 30 drives the locking gear 20 to rotate clockwise; however, since the locking gear 20 is locked against the locking wheel 19 through the second clutch mechanism, the locking gear 20 cannot move, and when the fine-tuning gear 31 continues to rotate, the pivot gear 30 rotates leftward around an outer ring of the locking gear 20 with a pivot of meshed engagement between the pivot gear 30 and the locking gear 20; since the pivot gear 30 is mounted on the second mounting plate 22, the second mounting plate 22 rotates relative to the mounting shaft 21, the second clutch pins 23 on the second mounting plate 22 move slightly toward the deep ends of the second clutch slots 24, and in this case, the completely locked state of the locking wheel 19 and the locking gear 20 is released, and the locking gear 20 rotates clockwise relative to the locking wheel 19 at a certain angle; in this case, the lifting part 2 moves downward along the rack 4 for a certain distance, and the target object on the lifting plate 5 moves downward with the lifting part 2 for a certain distance synchronously, such that downward fine-tuning of the target object is achieved, the target object is manually fine-tuned to an expected height downward, practicability of the jacking device is enhanced, and the user’s needs for fine-tuning the target object downward are met.

Preferably, a pressing port 38 for an outer end of the fine-tuning switch 33 to extend outside the lifting part 2 is arranged at a top of the lifting part 2, an abutment platform 39 is arranged inside the pressing port 38, the abutment platform 39 is provided with an abutment groove 40, and a reset spring 41 is arranged between the abutment platform 39 and the fine-tuning switch 33; a bottom end of the reset spring 41 is located inside the abutment groove 40 and abuts against a bottom of the abutment groove 40, a lower surface of the fine-tuning switch 33 is connected to a pressing plate spring 47, the pressing plate spring 47 is L-shaped, and the pressing plate spring 47 includes a horizontal portion 48 and a vertical portion 49, where the horizontal portion 48 is connected to the lower surface of the fine-tuning switch 33, a top end of the reset spring 41 abuts against a bottom face of the horizontal portion 48, and the vertical portion 49 is located on one side of the third mounting plate 35 and abuts against the third mounting plate 35; a fixed shaft 42 is further fixedly arranged inside the lifting part 2, the driven gear 8 is sleeved on the fixed shaft 42, a fixed handle 43 is further arranged on the lifting part 2, the fixed handle 43 is located below the driving handle 9, an inner end of the fixed handle 43 is located inside the lifting part 2 and connected to the fixed shaft 42, the inner end of the fixed handle 43 is provided with a limiting groove 44, and the driven gear 8 is located inside the limiting groove 44; arrangement of the pressing port 38 ensures that an outer end of the jacking device smoothly extends outside the lifting part 2, and when the user presses the fine-tuning switch 33 to rotate, the fine-tuning switch 33 drives the connecting shaft 34 to rotate, the connecting shaft 34 drives the fine-tuning wheel 32 to rotate clockwise, and the third clutch slots 37 on the fine-tuning wheel 32 also rotate clockwise; in this case, the third clutch pins 36 on the third mounting plate 35 move relative to the third clutch slots 37, and the third clutch pins 36 move from the deep ends of the third clutch slots 37 to the shallow ends of the third clutch slots 37, such that third clutch pins 36 are locked against the fine-tuning wheel 32 and the fine-tuning gear 31, and the fine-tuning wheel 32 and the fine-tuning gear 31 enter the locked state; when the user continues to press the fine-tuning switch 33, driving of the fine-tuning wheel 32, the fine-tuning gear 31, the third clutch pins 36, and the third mounting plate 35 to rotate synchronously and clockwise is performed, and in this process, the fine-tuning switch 33 drives the pressing plate spring 47 to rotate; since the vertical portion 49 of the pressing plate spring 47 is located on one side of the third mounting plate 35 and abuts against the third mounting plate 35, when the pressing plate spring 47 rotates, the vertical portion 49 of the pressing plate spring 47 applies pressure to the third mounting plate 35, which ensures that when the third mounting plate 35 for mounting the third clutch pins 36 rotates clockwise with the fine-tuning wheel 32 and the fine-tuning gear 31, the third mounting plate 35 cannot rotate counterclockwise independently, thereby ensuring that the third clutch pins 36 on the third mounting plate 35 remain at the shallow ends of the third clutch slots 37; when the fine-tuning switch 33 is pressed, the fine-tuning wheel 32 and the fine-tuning gear 31 remain locked, such that a fine-tuning function of the jacking device is not affected; since the bottom end of the reset spring 41 is located inside the abutment groove 40 and abuts against the bottom of the abutment groove 40, and since the top end of the reset spring 41 abuts against the bottom face of the horizontal portion 48, when the fine-tuning switch 33 is pressed, the horizontal portion 48 rotates downward with the fine-tuning switch 33, and the reset spring 41 enters a compressed state; when the user releases the fine-tuning switch 33, the compressed reset spring 41 pushes the horizontal portion 48 and the fine-tuning switch 33 to automatically reset, such that the user does not need to manually reset the fine-tuning switch 33, but may further press the fine-tuning switch 33 next time; when the fine-tuning switch 33 is not in use, the reset spring 41 further provides support for the pressing plate spring 47; the driven gear 8 is rotatably arranged inside the lifting part 2 through the fixed shaft 42, the fixed handle 43 on the lifting part 2 is arranged above the driving handle 9, the inner end of the fixed handle 43 is located inside the lifting part 2 and connected to the fixed shaft 42, and the driven gear 8 mounted on the fixed shaft 42 is just located inside the limiting groove 44 at the inner end of the fixed handle43, which effectively limits the lateral movement of the driven gear 8 on the fixed shaft 42, and ensures that the driven gear 8 remains meshed with the rack 4; the lifting part 2 is driven to move upward normally when the user presses the driving handle 9, and the fixed handle 43 cooperates with the driving handle 9; and the user may grip both the fixed handle 43 and the driving handle 9 simultaneously, when the user grips, and the driving handle 9 is driven to rotate downward, thereby facilitating the downward movement of the driving handle 9 in a way of pressing by the user.

The above are preferred examples of the present disclosure and are not intended to limit the protection scope of the present disclosure. Therefore, any equivalent changes made based on the structure, shape and principles of the present disclosure shall fall within the protection scope of the present disclosure.

1. A jacking device, comprising a fixed part and a lifting part arranged on the fixed part, wherein the fixed part comprises a base and a rack vertically arranged on the base, the lifting part is slidably arranged on the rack, the lifting part is provided with a lifting plate, the lifting part is internally provided with a climbing mechanism configured for driving the lifting part to move upward along the rack, the climbing mechanism comprises a driving gear rotatably arranged inside the lifting part, the driving gear is directly or indirectly meshed with the rack, driven rotation of the driving gear drives the lifting part to move upward along the rack, the lifting part is provided with a driving handle, an inner end of the driving handle is rotatably connected to the lifting part, the inner end of the driving handle is provided with a driving element, the driving gear is sleeved on the driving element, a first clutch mechanism is arranged between the driving element and the driving gear, the driven rotation of the driving handle drives the driving element to rotate synchronously, the driving element is locked against the driving gear through the first clutch mechanism, which drives the driving gear to rotate synchronously, in this case, the driving gear moves upward relative to the rack, which simultaneously drives the lifting part to move upward along the rack, when the driving handle is reset, the driving element and the driving gear are in a disengaged state, the lifting part is provided with a locking mechanism, and the locking mechanism limits downward movement of the lifting part.

2. The jacking device according to claim 1, wherein the climbing mechanism further comprises a driven gear rotatably arranged inside the lifting part, the driving gear is meshed with the driven gear, the driven gear is meshed with the rack, the driven rotation of the driving gear drives the driven gear to rotate synchronously, and in this case, the driven gear moves upward along the rack, which simultaneously drives the lifting part to move upward along the rack.

3. The jacking device according to claim 1, wherein the lifting part is provided with a first mounting plate, the first clutch mechanism comprises a plurality of first clutch pins, the first clutch pins are arranged on the first mounting plate, the driving element is annularly provided with a plurality of first clutch slots, and each of the first clutch slots has a shallow end with a depth less than a diameter of each of the first clutch pins and a deep end with a depth greater than or equal to the diameter of each of the first clutch pins; and when the first clutch pins are located at the deep ends of the first clutch slots, the driving element and the driving gear are in a disengaged state, the driven rotation of the driving handle drives the driving element to rotate synchronously, and in this case, the first clutch pins are located at the shallow ends of the first clutch slots and locked against the driving element and the driving gear, and the driving element and the driving gear are in a locked state.

4. The jacking device according to claim 1, wherein a rotating shaft is rotatably arranged inside the lifting part, the inner end of the driving handle is located inside the lifting part and fixedly connected to the rotating shaft, and the driving element is fixedly sleeved on the rotating shaft; and a first mounting rod is laterally arranged inside the lifting part, a second mounting rod is arranged on the driving handle, a first tension spring is arranged between the first mounting rod and the second mounting rod, and both ends of the first tension spring are connected to the first mounting rod and the second mounting rod.

5. The jacking device according to claim 1, wherein the locking mechanism comprises a locking wheel fixedly arranged inside the lifting part and a locking gear sleeved on the locking wheel, the locking gear is directly or indirectly meshed with the rack, a second clutch mechanism is arranged between the locking gear and the locking wheel, and the locking gear is locked against the locking wheel through the second clutch mechanism.

6. The jacking device according to claim 5, wherein the lifting part is internally provided with a mounting shaft, the locking wheel is fixedly sleeved on the mounting shaft, the locking gear is rotatably sleeved on the locking wheel, and a second mounting plate is further rotatably sleeved on the mounting shaft; the second clutch mechanism comprises a plurality of second clutch pins arranged on the second mounting plate, the locking wheel is provided with a plurality of second clutch slots, and each of the second clutch slots has a shallow end with a depth less than a diameter of each of the second clutch pins and a deep end with a depth greater than or equal to the diameter of each of the second clutch pins; when the second clutch pins are located at the shallow ends of the second clutch slots, the second clutch pins abut against the locking wheel and the locking gear, and the locking wheel and the locking gear are in the locked state; and a rapid drop switch is rotatably arranged on the lifting part, an inner end of the rapid drop switch is located inside the lifting part and abuts against the second mounting plate, when the rapid drop switch is pressed to push the second mounting plate to rotate, the second clutch pins on the second mounting plate move from the shallow ends of the second clutch slots to the deep ends of the second clutch slots, and the locking wheel and the locking gear are in the disengaged state.

7. The jacking device according to claim 6, wherein a third mounting rod is arranged at the inner end of the rapid drop switch, a fourth mounting rod is arranged on the second mounting plate, a second tension spring is arranged between the fourth mounting rod and the third mounting rod, both ends of the second tension spring are connected to the fourth mounting rod and the third mounting rod, the second mounting plate is provided with a fifth mounting rod, the first mounting rod is laterally arranged inside the lifting part, a third tension spring is arranged between the fifth mounting rod and the first mounting rod, and both ends of the third tension spring are connected to the first mounting rod and the fifth mounting rod.

8. The jacking device according to claim 6, wherein the lifting part is further provided with a fine-tuning mechanism, and the fine-tuning mechanism comprises a pivot gear rotatably connected to the second mounting plate, a fine-tuning wheel rotatably arranged inside the lifting part, a fine-tuning gear sleeved on the fine-tuning wheel, and a fine-tuning switch that drives the fine-tuning wheel to rotate, wherein a third clutch mechanism is arranged between the fine-tuning gear and the fine-tuning wheel, the fine-tuning gear is locked against the fine-tuning wheel through the third clutch mechanism, the pivot gear is arranged above the locking gear and meshed with the locking gear, and the fine-tuning gear is meshed with the pivot gear.

9. The jacking device according to claim 8, wherein a connecting shaft is rotatably arranged inside the lifting part, an inner end of the fine-tuning switch is located inside the lifting part and fixedly connected to the connecting shaft, the fine-tuning wheel is fixedly sleeved on the connecting shaft, and a third mounting plate is further rotatably arranged on the connecting shaft; the third clutch mechanism comprises a plurality of third clutch pins arranged on the third mounting plate, a plurality of third clutch slots are formed on the fine-tuning wheel, and each of the third clutch slots has a shallow end with a depth less than a diameter of each of the third clutch pins and a deep end with a depth greater than or equal to the diameter of each of the third clutch pins; when the third clutch pins are located at the deep ends of the third clutch slots, the fine-tuning wheel and the fine-tuning gear are in the disengaged state, and when the fine-tuning switch is pressed, the connecting shaft and the fine-tuning wheel are driven to rotate; and in this case, the third clutch pins are located at the shallow ends of the third clutch slots and abut against the fine-tuning wheel and the-tuning gear, and the fine-tuning wheel and the fine-tuning gear are in the locked state.

10. The jacking device according to claim 8, wherein a pressing port for an outer end of the fine-tuning switch to extend outside the lifting part is arranged at a top of the lifting part, an abutment platform is arranged inside the pressing port, the abutment platform is provided with an abutment groove, and a reset spring is arranged between the abutment platform and the fine-tuning switch; a bottom end of the reset spring is located inside the abutment groove and abuts against a bottom of the abutment groove, a lower surface of the fine-tuning switch is connected to a pressing plate spring, the pressing plate spring is L-shaped, and the pressing plate spring comprises a horizontal portion and a vertical portion, wherein the horizontal portion is connected to the lower surface of the fine-tuning switch, a top end of the reset spring abuts against a bottom face of the horizontal portion, and the vertical portion is located on one side of the third mounting plate and abuts against the third mounting plate; a fixed shaft is further fixedly arranged inside the lifting part, the driven gear is sleeved on the fixed shaft, a fixed handle is further arranged on the lifting part, the fixed handle is located below the driving handle, an inner end of the fixed handle is located inside the lifting part and connected to the fixed shaft, the inner end of the fixed handle is provided with a limiting groove, and the driven gear is located inside the limiting groove.
